(19) United States
(12) Patent Application Publication
(10) Pub. No.: US 2002/0107073 A1
(43) Pub. Date: Aug. 8, 2002

(54) Interactive game system and method

(76) Inventor: Mark Stephen Binney, Rocklin, CA (US)

Correspondence Address: Daniel P. Maguire, 423 E Street, Davis, CA, 95616, US

(21) Appl. No.: 09/996,549

(22) Filed: Nov. 27, 2001

Related U.S. Application Data
(60) Provisional application No. 60/253,421, filed on Nov. 27, 2000.

(51) Int. Cl. A63F 13/00

(52) U.S. Cl. 463/42; 463/1

(57) ABSTRACT

A system and method for executing an interactive game. A system according to an embodiment is executed on-line by users using browsers. A statistics engine forms a portion of a web server that receives statistics from a plurality of statistical sources, and awards points to users who have formed fantasy teams. In one embodiment, statistics relate to amateur athletic sporting events. Each fantasy team includes players that represent a team, and preferably an amateur team in one exemplary embodiment. An advertisement engine forms another part of the web server, for serving advertisements to users. A sales engine forms another part of the web server, for receiving and executing sales requests of sports-related items, or other goods.

### CROSS-REFERENCE TO RELATED APPLICATION

The present invention claims priority based on the provisional application of the same title filed by Mark S. Binney on Nov. 27, 2000.

### BACKGROUND OF THE INVENTION

1. Field of the Invention

This invention relates to games, and more particularly to an interactive game system and method using a fantasy roster based on real teams or units.

2. Description of the Related Art

Several types of fantasy contests exist. One type of fantasy contest is generally known as “Fantasy Sports.” In Fantasy Sports, participants assemble a “Fantasy Team” where each player of the team represents an actual player from one of a number of professional sports teams. The Fantasy Team is a fictitious team whose players are chosen by the participant. For example, in a Fantasy Football contest, participants will assemble a team by assigning actual players from various teams to their associated positions in the participant's Fantasy Team. Participants make selections based on statistics about each player that are compiled each year by various publications. Then, based on each player's actual performance during actual contests, a score is generated for the Fantasy Team. Individual players can be traded, played or benched, just as in the actual associated sports league.

In some fantasy sports leagues, a group of participants organize and execute a “draft” of available real players for their respective teams. Thus, each real player may be drafted to one or several participant's teams to the exclusion of all other participants' teams. Participants may later execute a trade of players with other participants to modify their rosters.

Most fantasy sports contests are based on players from a single league of the sport on which the fantasy contest is based. For example, fantasy football teams are conventionally based only on the National Football League™ teams and individual players.

Another type of fantasy contest is known as a Fantasy Stocks, where a participant assembles his or her list of actual publicly-traded stocks for a Fantasy portfolio, without actually having to pay for the stocks. Since performance data is published and readily available on all stocks, participants in such a contest can ascertain their performance vis-à-vis other players, the actual market indices, or any other benchmark.

In such fantasy contests as the foregoing, the players on a fantasy team, or listings on a fantasy portfolio, represent actual individual players or individual stocks, respectively. Further, such fantasy contests are competitive, i.e. a participant advances to the detriment of other participants in a particular contest.

### SUMMARY OF THE INVENTION

This invention relates to a novel fantasy contest system and method. In one embodiment of the invention, entire amateur sports teams are selected as players or as a player-coach for a fantasy team. Based on a win-loss record of each selected team, a participant earns points. An alternative embodiment of the invention adds points for other achievements, such as community service, school scholastic record of a participant, or for a participant performing some function on a network.

In an embodiment of the invention, a fantasy contest is hosted on a contest server coupled to a network, such as the Internet. Participants can access the contest server based on access data provided by the participant. Participants enter data to the contest server based on their selection of their roster. The roster may comprise amateur sports teams in one embodiment. Each roster may include one sports teams as one “player” of the roster, and the teams may be selected from various leagues or geographical locations, etc. In another embodiment, the roster may include other entities, such as a group of publicly traded stocks designated as one “player” for example.

### BRIEF DESCRIPTION OF THE DRAWINGS

FIG. 1 illustrates a system for conducting an interactive game according to an embodiment of the invention.

FIG. 2 is a process flow diagram of an embodiment of the invention.

FIG. 3 is a functional block diagram of an embodiment of a statistics engine 104, shown in FIG. 1.

FIG. 4 illustrates a graphical user interface of an embodiment of the invention.

### DETAILED DESCRIPTION OF THE PREFERRED EMBODIMENTS

In an embodiment of the invention, a system for executing a game includes a game interface, a statistics engine, and a statistical source interface. The game interface comprises a portion of a Web server adapted for communication with a plurality of client computers. The game interface includes user functions and displays. The statistics engine is configured maintain a database of actual leagues and actual teams that represent players of a fabricated team, according to an embodiment of the invention. The statistics engine is also configured to update fabricated teams with changed actual teams and leagues, depending on factors that could include seasons, weather, etc. The statistics engine also administers and disperses points based on scores accumulated by participants. In one embodiment, the statistics engine receives a plurality of disparate statistical formats from many sources, which statistics includes scoring, win/loss records, etc. The statistical source interface connects the statistics engine to each one of the plurality of statistics sources. In an alternative embodiment, the statistical source interface is adapted to receive data from any of a preselected plurality of statistics sources.

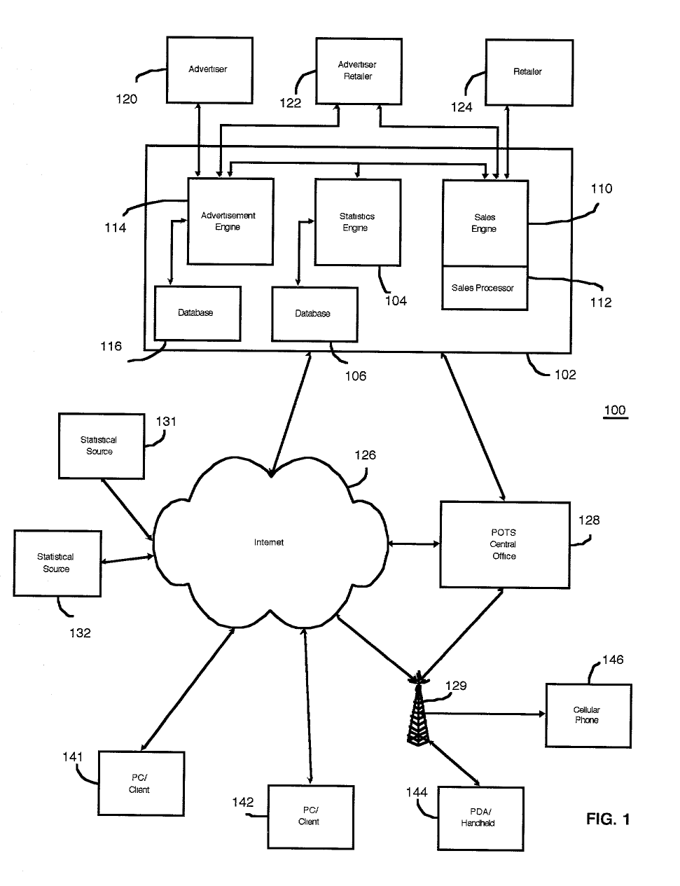

FIG. 1 illustrates a system 100 according to an embodiment of the invention, on which an interactive game may be suitably executed. The system 100 includes a web server 102. The web server 102 includes a statistics engine 104 coupled with a database 106, for storing statistics and processing points to users. The web server 102 further includes a sales engine 110 that interfaces with retailers 124 and advertiser/retailers 122, for generating a sales process. The sales process can include offering a product for a limited time period, redeemable for a user's accumulated points, to generate interest in the product. Then, the product could be offered for sale for actual currency. The sales engine 110 includes a sales processor 112 for executing all sales transactions.

The web server 102 further includes an advertisement engine 114 coupled with an ad database 116, for generating and serving advertisements to users who use the game system 100. The advertisement engine 114 interfaces with a plurality of advertisers 120 and advertiser/retailers 122, for receiving ads about products and/or services, and generating revenue.

The web server 102 is coupled with a network 126, such as the Internet or World Wide Web (WWW). The network 126 is adapted for two-way communication between advertisers, retailers and users, as well as the web server 102. A plurality of statistical sources 131, 132 are connected with the web server 102 via the network 126, or other communication means, to provide statistics about sports contests, stocks, etc. A plurality of clients 141, 142 are coupled to send and receive data between the web server 102 via the network 126. The clients 141, 142 represent users using web browsers in one embodiment, for example. The clients 141, 142 set up teams and play the online game, and are adapted to receive advertisements, and conduct sales transactions.

In alternative embodiments, users can use a PDA or handheld device 144 to access the web server 102. Or, the users can access the web server 146 via cellular or wireless device 146, coupled via a wireless network 129 that is connected to the network 126. In some cases, communication may be conducted through a plain-old telephone system 128, or other land-based communication node. In other cases, communication may occur over cable, fiber optics, or satellite.

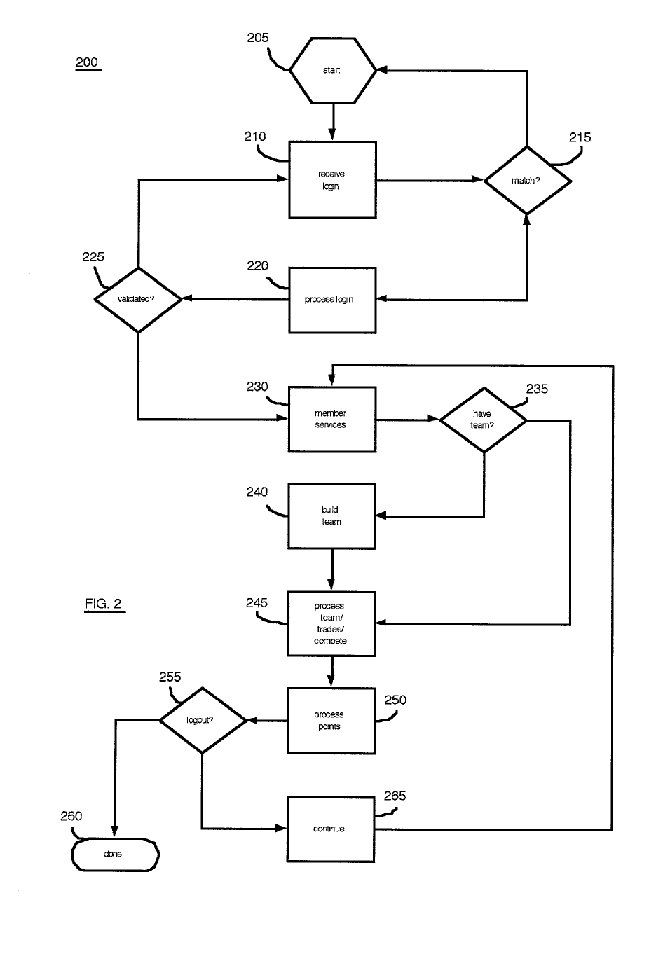

FIG. 2 illustrates one method of the invention. A process 200 includes a start block 205. At block 210, a user login is received. If it is a match, the login is validated at block 225 after processing at block 220. If it is not a match, another login is received at block 210 or the process may be terminated. Once validated, the user is provided to block 230, wherein the user can access an interactive game according to the invention. For example, the user can build a team at block 240, or process a team at block 245 if the user has already built one. At block 250, a game may be executed and points processed. At block 255 the user may logout. If logout is accomplished, the process is done at block 260. However, if logout is not accomplished, the user may continue the process at block 265.

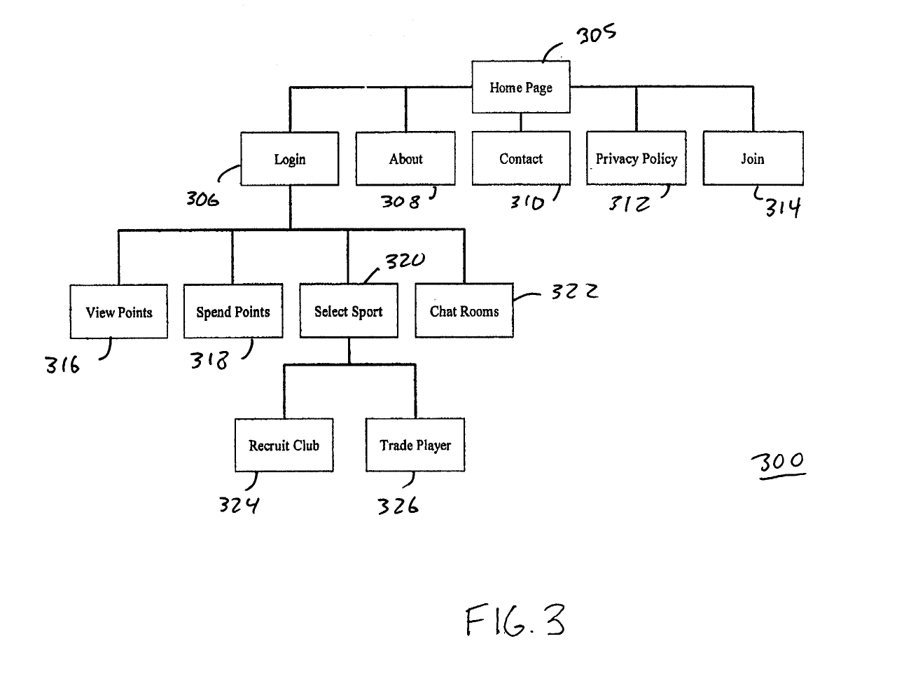

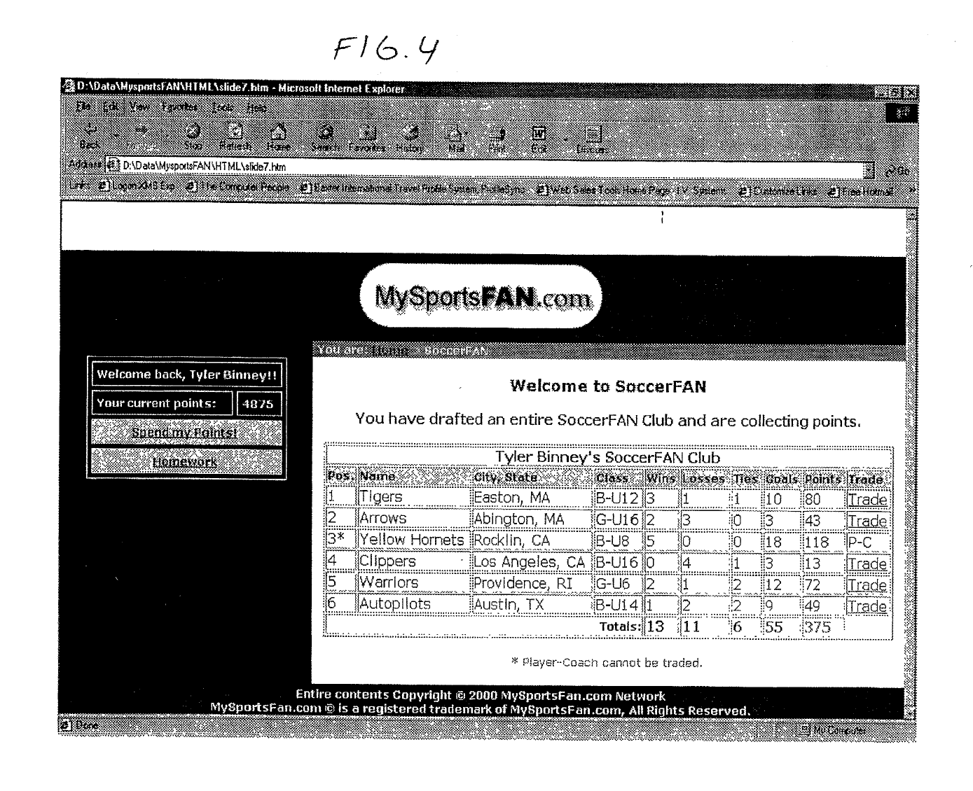

FIG. 3 shows a functional block diagram 300 of a statistics engine 104 according to one embodiment of the invention. A system and method according to the invention is adapted to interface with any type of game that includes teams and statistics kept between the teams. A system and method of the invention allocates points to participants, and allows the participants to redeem the accumulated points for prizes. FIG. 4 shows a graphical user interface, in which a team is illustrated. In particular the team comprises five players and one player coach. The players represent teams, or other entities. The players may be traded, played, or benched. The player-coach also represents a team or other entity, but may not be traded, etc.

In a specific exemplary embodiment, a participant could fabricate a team whereby each player of the team is a separate portfolio of publicly-traded financial stocks. In one example, a portfolio of ten stocks is designated as a player-coach for a fixed period of time, during which the player-coach may not be dispensed with by the participant. Other players of a participant's team are comprised of other portfolios, each including a predetermined number of stocks. Points could be allocated based, for example, a performance of the team as measured against market indices, actual funds such as mutual funds, or other teams formed by participants. In an exemplary embodiment, points could be awarded as a percentage performance difference from a stated benchmark.

Points that are accumulated by participants can redeemable for products, thus one method of the invention provides for a non-competitive game in which a participant earns points only through personal performance of a selected team, and not based on relative performance of other participants.

An example of a game system according to the invention includes a statistical source comprised of youth soccer leagues. In an embodiment, a game system includes a reality-based soccer game, and an on-line interconnected community of participants in the soccer game. A player-coach is first selected, which can be a actual team on which a participant plays, or an actual team from an actual league in which a relative of a participant plays. A number of other players are selected to form a fabricated team. In the example embodiment, the team is termed a “Soccer Club.” All players except the player-coach of the fabricated team my be dropped and/or added, in a step known as a “trade,” so long as a maximum number of players is not exceeded. The following rules apply, according to one particular embodiment:

1) Game Points are based on the scores of the particular sport and is a scalable formula depending on the sport (i.e. a football score is significantly higher then a soccer score).

2) Partner Points, which are conceptually similar to points awarded in Frequent Flier programs with the airlines; e.g. United Airlines has partnered with MCI, Visa and Safeway for miles per dollar spent, are based on events outside of the particular game being modeled by the fabricated team, such as educational achievement or extracurricular activities of a participant.

3) Bonus Points are awarded to a participant for performing certain predetermined functions or acts, such as navigating on-line through partner merchant web sites, for example.

In accordance with the invention, various segments of the game may be isolated. The following is an example breakdown of segments according to a demographic distinction:

1) Youths, age range is from 5-19 years old and their parents

2) High School 14-20 years old, their teachers and kids parents

3) College students 20-26, all post grad and their professors and parents

4) Sponsored members (sponsored by the 3 segments above) through the Umbrella Program (see Umbrella Program under Rules).

Other distinctions can be used when desirable. Further, an entire game may be played without any distinctions between different segments.

Point totals can be updated according to regular intervals, such as once every week, for each participant. Other intervals may also be used, or an embodiment of the system and method can update each participants' points table dynamically.

Participation is made accessible to a participant using a computer to communicate through the Internet. Preferably, the participant also has an electronic mail account, and uses a browser program to interface with and display various Web pages that are downloaded from a game interface server. One example of a participant is a child that plays a sport. Other participants include the coaches coaching the child's team. However, according to the embodiment, the child and/or coaches can sponsor other participants. In the sponsored mode, called the Umbrella program, special bonus points may be awarded, and an association between a participant and the sponsored participant is stored in a table of the participant database. Examples of sponsored participants include mothers, fathers, grandparents, godparents, and friends of the child or coach, or anyone associated with a primary participant.

Example Rules

The following rules apply to a system and method of a game, according to one embodiment of the invention. Modifications and changes to the embodiment may be executed without departing from the scope and meaning of the invention.

Build your Soccer Club

A participant forms a “club.” In order to receive points for a club, a participant needs to acquire 5 players, which can be actual, physical teams. A participant may not select all players from any one particular division, and must have a player-coach on a permanent basis, i.e. the player-coach can never be traded. Thus, the team, or club will include the player-coach and five other players.

Game Points

Points earned by selected players will be based on how actual teams perform in real life games, such as USYSA-scheduled games in an entire season—from the first game through the last game of a season.

Win—20 points

Tie—10 points

Loss—0 points

Goal—I point

Partnerpoints

1500 points/yr—Honor student

2000 points/yr—High Honor student

1000 points/yr—Brownies, Girl Scouts and Boy Scouts affiliation

Bonus Points

25 points/person—Umbrella Program

5 points—Every Logon

2 points—Advertising Hits

1 point—Each active length of online session, such as every 10 minutes

Drafting

Draft day is predesignated, such as the day a participant signs-up for the actual USYSA game season, if the participant in the online game system and method is also an actual player on an actual team. The participant accesses the Web via the Internet and should have an e-mail address from which the participant may send and receive electronic messages.

A participant can trade and acquire a player at any time, BUT the team or club lineup shall be frozen at a predetermined time and day, and for a predetermined duration. A participant may only get points for players who were on the team or club for the games played that day.

Trading may be accomplished according to a stipulation, or a maximum point variance between a dropping team and an adding team. For example, participant A's Soccer Club wants to trade player 1 (Rocklin Rocks girls U-13) which has 201 points, and acquire player 2 (Rocklin Rockets boys U-13) has 251 points, this trade would be possible since the difference is not more than 50 points.

Trading Services

Each participant will be allowed unlimited trading privileges via email. The participant may comprise a player-coach of that participant's fabricated team. Trading can be done at any time during a season of a particular modeled sport of endeavor.

A participant cannot have the same player twice on their team at the same time. They can however, trade a player and then re-acquire the player multiple times throughout the season.

Following is an example trade executed automatically via e-mail:

Participant A's Soccer Club is offering the following trade:

Rocklin Rockets girls U-13 for Rocklin Rose's girls U-13

If this point total trade (50 points or less) is accepted, the trade is updated on Participant A's Soccer Club roster of players. The Rockets will be deleted and the Rose's will be added. All changes are made immediately after acceptance.

Other Functions

Member Sign-Up

Participants must first sign-up to gain access to the system and method. One simple sign-up process will ask for a valid email address, first name, last name, and a password twice (for validation purposes) After the user has signed up, they will automatically be granted access to the system network for life.

Build Clubs

A function of the game interface is to allow members to build clubs. Clubs may be built for any active season. In one embodiment, a club has 6 players, one of which has been designated the player-coach. Once an entire club or team has been fabricated, game points can begin to be accumulated and dispersed.

Research Players

A thorough research page will be accessible which allows for research and comparison of players or teams in an active season. The research page for each sport will also link directly to a participant's account to allow for ‘Instantaneous Trades.’ The system can also rank players, i.e. how quickly stats for the player are acquired and Game Points dispersed.

Trade Players

Another function of the game interface is to allow members to trade players in their Club. This is a simple, intuitive, and user-friendly interface. Rules for trading players can include: 1) the player-coach may not be traded, and 2) the trading variance between two teams (total points gained for team 1−total points gained for team 2) must not be greater than a stated maximum, i.e. 50 points. This trading variance places a great deal of strategy into the trading system.

View Points

A View Points Interface will allow members to receive a detailed audit on how all of their points have been acquired. This will act as a ‘Bank Statement’ of sorts showing all credits and debits to their Points Account from a points database.

Spend Points

Spending points, in accordance with an embodiment of the invention, may be accomplished once per stated interval, such as weekly. For example, every Thursday at 12:00 pm EST the latest Reward Lottery will be released. Members have 48 hours to spend their points. The system will allow for unlimited Reward Selections based on earned points until the bank account balance is zero. At 12:00 pm EST on Sunday all winners will be posted and notified via e-mail. Each point counts as once chance to win the lottery. Multiple points may be spent on any of the 10 rewards until the member's Point Bank Account reaches zero. If the member fails to win any rewards, they will be reimbursed 50% of their points. If a member uses 500 points to win a Vacation, but they are not drawn as a winner, they will receive 250 points back.

Acquire Partner Points

Partner points may be acquired by downloading a Word/Adobe Acrobat Reader Document, filling out the form, Attaching the designated proof of Partner Point Eligibility, and submitting the application via the United States Postal Service. All applications will be reviewed and points will be dispersed within 4 to 6 weeks upon receipt of Application.

Acquire Bonus Points

Bonus points may be acquired in many different ways. To acknowledge receipt of bonus points, a participant must perform an acknowledgement function. Bonus points will be marked appropriately in the participant database.

Open Chat Rooms

Open chat rooms will be available to all participants. This will be a collaboration and information-sharing tool. Participants can share strategy and discuss the game in these chat rooms. Chat rooms will be moderated.

Statistics Engine

Import Accurate Teams

At the beginning of every season, an accurate team list must be imported. The Import Accurate Teams function will clear all previous teams and build a fresh list of available teams before the season begins. Team lists will be arriving from many different sources. The Chameleon System will adapt to handle all incoming team lists for all sports.

Disperse Game Points Based On Team Scores

The statistics engine will also disperse points stored in a statistics database. As new statistics arrive via the statistical source interface from each of the statistical sources, the statistics engine can determine what fabricated team won, how may points the contest is worth, and then reward all applicable participants the correct amount of points, automatically.

Statistical Source Interface

Catalog

The a statistical source catalog will be an ever growing catalog of interfaces specifically designed to manage different statistical formats from the various sources, from season to season. The statistical source interface can eventually grow to handle all possible statistical sources ranging from the AP Newswire to a human interface, i.e. sport administrators who enter scores manually.

Raffle Administration User Documentation

Add Raffle

Generate Yearly Raffles

This function will automatically generate raffles for an entire year, with 10 Reward slots Designated for each raffle. The administrator will also be given access to edit any single piece of information for each raffle.

Raffle Name

There will be 52 raffles in MySportsFAN each year. The Raffle Name will be similar to the format Week 23-2001 Raffle. The Raffle Name will allow easy identification of the Raffle in a list of all Raffles.

Date/Time of Begin Submissions

This Date/Time will typically default to each Thursday at 12:00 pm EST for each week throughout the year.

Date/Time of End Submissions

This Date/Time will typically default to each Saturday at 12:00 pm EST for each week throughout the year.

Date/Time of Drawing

This Date/Time will typically default to each Sunday at 12:00 pm EST for each week throughout the year.

Edit Raffle

Edit Raffle Name

The designated Raffle Name will be editable by the Administrator.

Edit Date/Time of End Submissions

The date/time of End Submissions will be editable by the Administrator.

Edit Date/Time of Drawing

The date/time of Drawing will be editable by the Administrator.

Add Raffle Prizes (10)

This is the only Mandatory Administration Feature in the system and method of the invention. For each week throughout the year, a number of prizes must be associated with each raffle. The Administrator is able to Add the number of Raffle Prizes to any future raffle which has been created. The number of prizes rewarded in this raffle must also be designated. For instance, 1000 fast food gift certificates may be rewarded.

Execute Raffle

Pick Prizewinners

This Function will be automated upon expiration of a predetermined interval, such as weekly. Prizewinners will be notified by email.

View Raffle History

View All Raffles

A list of all Raffles will be available to the Administrator—Past or Present. The Administrator may view detailed information regarding any raffle.

View Raffle Prizes

The Administrator will be able to view each Raffle Prize Rewarded for any completed raffle.

View Raffle Prize Winners

The Administrator will be able to view each Raffle Prize Reward Winner for any completed raffle.

I claim:

1. A game wherein a participant selects sports teams to form a roster, wherein the participant receives points based on the performance of the sports teams in the roster, and wherein the participant redeems said points for chances to win a prize in a sweepstakes.

2. The game according to claim 1, wherein said sports teams comprise amateur sports teams.

3. The game according to claim 2, wherein said sports teams comprise youth league sports teams.

4. The game according to claim 3, wherein the participant is a member of one of the sports teams on the roster.

5. The game according to claim 4, wherein the participant also earns points for performing community service.

6. The game according to claim 5, wherein the participant also earns points for scholastic achievement.

7. The game according to claim 6, wherein the participant can change all but one of the teams on the roster.

8. The game according to claim 7, wherein the participant also earns points for visiting partner merchant web sites.

9. The game according to claim 8, wherein a number of participants take part in the game, and wherein an online chat room is provided for participants to discuss the game.

10. The game according to claim 9, wherein the participants are segregated by age in playing the game.

11. A game wherein a participant selects a first set of sports teams to form a first roster, wherein the participant selects a second set of sports teams in a different sport from the first set to form a second roster, wherein the participant receives points based on the performance of the sports teams in both rosters, and wherein the participant redeems said points for chances to win a prize in a sweepstakes.

12. A game wherein a participant selects sports teams to form a roster, wherein the participant receives points based on the performance of the sports teams in the roster, and wherein the participant uses said points to purchase products.

13. A game wherein a participant selects stocks to form a roster, wherein the participant receives points based on the performance of the stocks in the roster, and wherein the participant redeems said points for chances to win a prize in a sweepstakes.

14. A game wherein a participant selects stocks to form a roster, wherein the participant receives points based on the performance of the stocks in the roster, and wherein the participant uses said points to purchase products.

15. The game according to claim 14, wherein the participant also earns points for performing community service.

16. The game according to claim 15, wherein the participant also earns points for scholastic achievement.

17. The game according to claim 16, wherein the participant can change all but one of the teams on the roster.

18. The game according to claim 17, wherein a number of participants take part in the game, and wherein an online chat room is provided for participants to discuss the game.

19. The game according to claim 18, wherein the participants are segregated by age in playing the game.

20. An online game system, comprising:
a game interface accessible by a participant using a browser, said game interface allowing said participant to select sports teams to form a roster;
a statistics engine for computing points based on the performance of the teams in the participant's roster; and
a sweepstakes module for allowing the participant to redeem said points for chances to win a prize in a sweepstakes.

21. The game system according to claim 20, wherein said sports teams comprise amateur sports teams.

22. The game system according to claim 21, wherein said sports teams comprise youth league sports teams.

23. The game system according to claim 22, wherein the participant is a member of one of the sports teams on the roster.

24. The game system according to claim 23, wherein the participant also earns points for performing community service.

25. The game system according to claim 24, wherein the participant also earns points for scholastic achievement.

26. The game system according to claim 25, wherein the participant can change all but one of the teams on the roster.

27. The game system according to claim 26, wherein the participant also earns points for visiting partner merchant web sites.

28. The game system according to claim 27, wherein a number of participants take part in the game, and wherein an online chat room is provided for participants to discuss the game.

29. The game system according to claim 28, wherein the participants are segregated by age in playing the game.

30. A fantasy sports game, wherein participants select sports teams to form rosters, and wherein participants receive points based on the performance of the sports teams in their respective rosters.

31. The fantasy sports game according to claim 30, wherein said sports teams comprise youth league sports teams.

32. The fantasy sports game according to claim 31, wherein at least one participant is a member of one of the sports teams.

33. The fantasy sports game according to claim 32, wherein participants also earn points for performing community service.

34. The fantasy sports game according to claim 33, wherein participants also earn points for scholastic achievement.

35. The fantasy sports game according to claim 34, wherein participants can change all but one of the teams on their respective rosters.

36. The fantasy sports game according to claim 35, wherein participants also earns points for visiting partner merchant web sites.

37. The fantasy sports game according to claim 36, wherein participants are segregated by age in playing the game.

38. An interactive online computerized fantasy sports game system, comprising:
a sign-in module, allowing participants to sign on to the system using a password;
a roster-building module, allowing participants to build a roster comprised of actual sports teams by selecting teams from a list of eligible teams; and
a statistics engine, said statistics engine receiving data concerning performance of said sports teams, and said statistics engine computing points for participants based on the performance of each participant's roster.

39. The system according to claim 38, additionally comprising a trading module allowing participants to transfer teams into and out of their roster.

40. The system according to claim 39, additionally comprising a redemption module, allowing participants to redeem said points.

41. The system according to claim 40, wherein participants can redeem said points in exchange for chances in a sweepstakes.

42. The system according to claim 41, wherein participants can redeem said points by purchasing products.

43. The system according to claim 42, additionally comprising a research module, allowing participants to conduct research on the eligible teams.

44. The system according to claim 43, wherein said eligible teams are comprised of youth league teams.

45. The system according to claim 44, wherein one of said actual sports teams cannot be traded out of said roster.

46. The system according to claim 45, wherein at least one of the participants is a member of one of the eligible teams.

47. The system according to claim 46, wherein participants also earn points for performing community service.

48. The system according to claim 47, wherein participants also earn points for scholastic achievement.

49. The system according to claim 48, wherein participants also earn points for visiting partner merchant web sites.

50. The system according to claim 49, additionally comprising an online chat module.

51. The system according to claim 50, additionally comprising an advertising engine for displaying advertisements to the participants.
